(19) United States
(12) Patent Application Publication
(10) Pub. No.: US 2014/0008361 A1
(43) Pub. Date: Jan. 9, 2014

(54) COLLAPSIBLE HOPPER WITH CABLE ENGAGEMENT

(71) Applicant: Don Nguyen, Garden Grove, CA (US)

(72) Inventor: Don Nguyen, Garden Grove, CA (US)

(21) Appl. No.: 13/542,657

(22) Filed: Jul. 5, 2012

(51) Int. Cl. B65D 25/00

(52) U.S. Cl. 220/9.4

(57) ABSTRACT

A collapsible hopper having a bag, a frame and a cable engagement member is disclosed. The bag is connected to the frame, and the frame is connected to the cable engagement member. The bag is able to move between an extended posisiton and a collapsed position.

### BACKGROUND OF THE INVENTION

In the rearing of poultry and other live stock, some enclosures include feeding systems that are lowered from the ceilings and distribute food along conduits to feeding containers. The conduits can run hundreds of feet and have many food containers. There may also be many sets of these systems inside one enclusre running parallel and/or end to end.

When these feeding systems are lowered, hoppers installed, and food from the hopper is distributed to the feeding trays. The hopper may or may not receive feed from another food source. Sometimes, the hoppers are filled by hand. Once the food is supplied to the hopper, a system distributes the food from the hoppers to the feeding trays.

After the feeding is completed, the entire system is raised. The lines run from reeling in the ceiling. These lines attach to the feeding pipes and trays. However, in many systems, the hoppers must be removed because there is not enough room for the hoppers in the enclosures when the system is raised. The removal and enstalling process is time consuming and difficult for many workers in the industry.

Thus there is room for improvement in the art.

### SUMMARY OF THE INVENTION

An apparatus comprising:

a bag;

a frame; and

a cable engagement member;

wherein the bag is connected to the frame, and the frame is connected to the cable engagement member; and the bag is capable of moving between an extended position and a collapsed position.

The apparatus wherein the cable engagement member is a quick connect mechanism.

The apparatus wherein the cable engagement member is a Verlock.

The apparatus, further comprising a flange; wherein the flange is connected to the frame, and the cable engagement member is connected to the flange.

The apparatus, further comprising a cross member and a flange; wherein the cross member is connected to the frame, and the cable engagement member is connected to the flange.

The apparatus, wherein the cross member is attached to the frame at a connection point.

The apparatus wherein an angle is defined by the frame and the cross member, and the angle is in a range of about 15 degrees to 90 degrees.

The apparatus, further comprising a boot, and the boot comprises a conduit; wherein the cable engagement member is located above and aligned with the conduit when the bag is in the extended position.

The apparatus, further comprising an engagement element and an eye nut; wherein the eye nut is in contact with the cable engagement member and the engagement element is connected to the eye nut.

The apparatus, wherein the eye nut is angled.

The apparatus, wherein the flange is located at about a center of the cross member.

Te apparatus, further comprising a pouch located on an interior of the bag.

The apparatus, further comprising a fastener strip located in the pouch.

The apparatus, further comprising a sensor located in the pouch.

The apparatus, further comprising a boot, and the boot comprises a conduit; wherein the flange and the conduit extend along the same direction when the bag is in the extended position.

The apparatus, further comprising a guide and an engagement element.

The apparatus, further comprising an eye hook.

The apparatus, wherein the frame has a stiffness that is greater than a stiffness of the bag.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIGS. 1-2 show an embodiment of a collapsible hopper in an extended position;

FIG. 3 shows an embodiment of a collapsible hopper;

FIG. 4 shows an embodiment of collapsible hopper with a sensor in a pouch;

FIGS. 5-7 show an embodiment of the collapsible hopper;

FIGS. 8 and 10 to show embodiments employing engagement members; and

FIG. 9 shows an embodiment of an eye nut.

### DETAILED DESCRIPTION OF THE DRAWINGS

The disclosure, including the accompanying drawings, is illustrated by way of example and not by way of limitation. It should be noted that references to “an” or “one” embodiment in this disclosure are not necessarily to the same embodiment, and such references mean at least one.

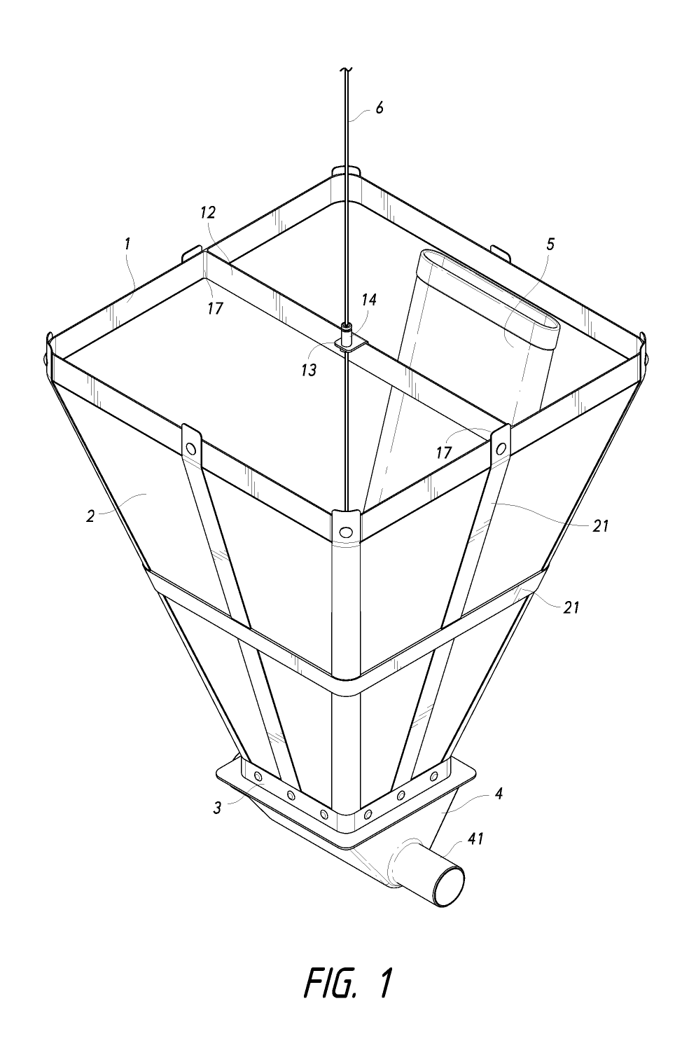

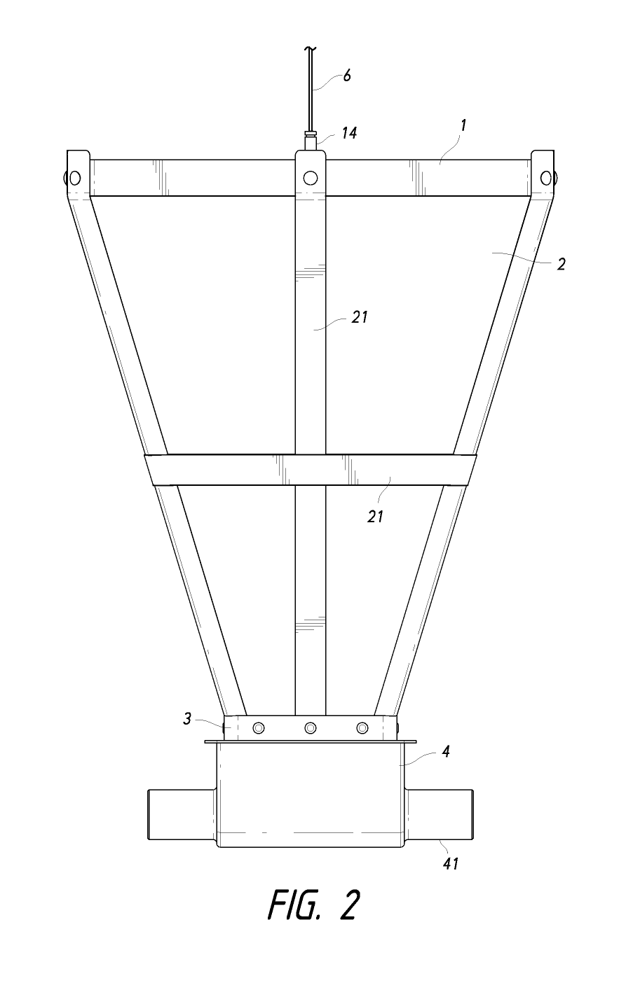

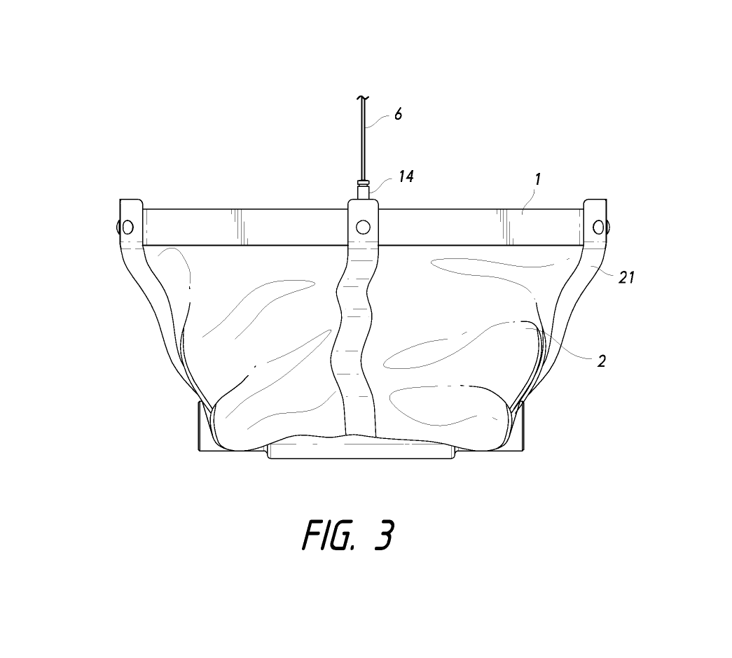

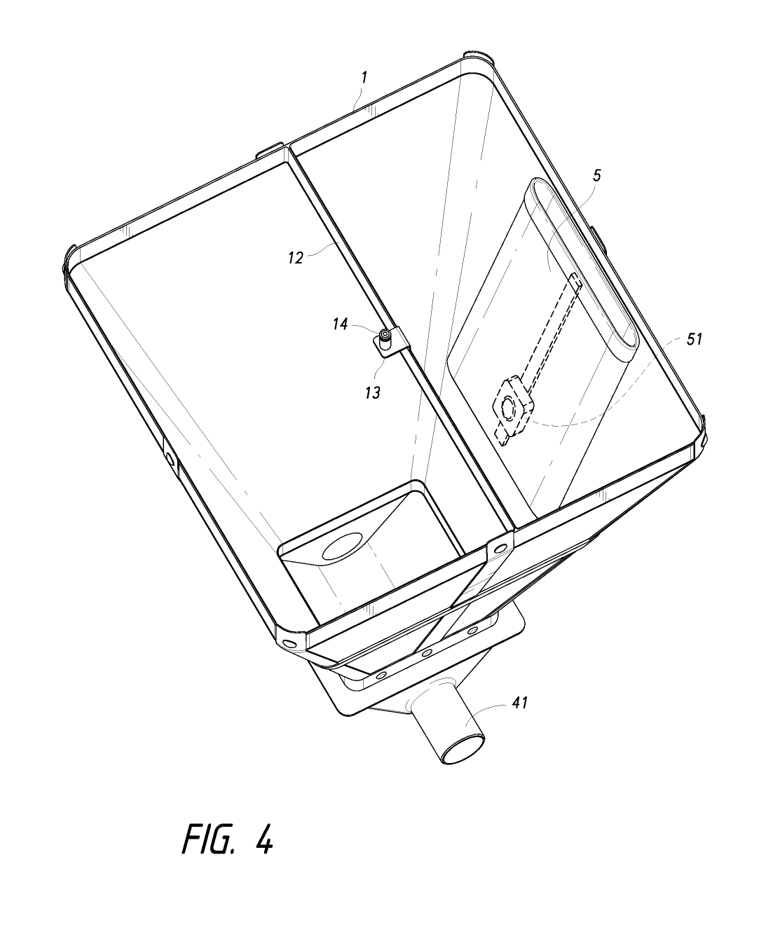

Referring to FIG. 1, an embodiment of a collapsible hopper is shown. The hopper comprises a frame 1, a bag 2, and an attachment 3. The hopper can further comprise a boot 4. The hopper is able to move between an expanded postion, an collapsed postion, and many positions in-between. The expanded position is shown in FIGS. 1 and 2, and the collapsed position is shown in FIGS. 3 and 4.

The frame 1 comprises an exterior 11, a cross member 12, a flange 13, and a cable engagement member 14. The exterior 11 and the cross member 12 can be of any rigid or semi-ridged material. In some embodiments, the exterior 11 and the cross member 12 are of the same material, integral or not. In other embodiments, the exterior 11 and the cross member 12 are of different materials, integral or not. The flange 13 is connected to the cross member 12. In some embodiments, the flange 13 and the cross member 12 are of the same material, integral or not. In other embodiments, the flange 13 and the cross member 12 are of different materials, integral or not. Located on the flange 13 is a cable engagement member 14. The frame 1 can be made of plastic, metal, wood, ceramics, and/or combinations thereof. The exterior 11 defines a regular or an irregular geometric shape. In some embodiments the exterior 11 defines a rectangle. Other examples shapes include, but is not limited to triangles, circles, and polygons.

The cross member 12 is shown extending perpendicular to the exterior at the connection point 17. In some embodiments, the cross member 12 will only connect to the exterior in one location. In other embodiments, the cross member 12 will extend diagonally, relative to the exterior at the connection point 17.

The bag 2 is made of a flexible material and may have reinforcing elements 21. It is understood that the reinforcing elements 21 may be just extra material of the bag 2 and/or linear members of a different material. The linear memebers may be of predetermined lengths so as to aid in a preferred folding when the bag 2 is collapsed. In some embodiments, the linear members are located in sleeves. In some embodiments, the flexible material comprises nylon, fabric, metal reinforced fabric, composites, woven fabrics, cotton, hemp, burlap, petroleum base materials, chainmail, flexible metal material, composites and/or combinations thereof.

The cable engagement member 14 is able to secure itself to a cable 6. In some embodiments, when the hopper is in the expanded position, the cable engagement member 14 is secured to the cable 6 and supports the frame 1 such that the hopper is in the expanded position. To move the hopper to the collapsed position, the cable engagement member 14 is disengaged from the cable 6 such that it can be slid down the cable 6 and collapse the hopper. It is understood that in the collapsed position, the frame 1 can partially rest on the distribution conduit(s) 41 or be partially suspended above the distribution conduit(s) 41.

In some embodiments, the cable engagement member 14 is a quick connect self-locking retention mechanism. An example of a quick connect that can be used is a portion of a Verlock sold by VER Sales, Inc out of Burbank, Calif. While the Verlocks are sold with an eye nut, one is able to remove the eye nut, place the Verlock on the flange 13 and secure it with a nut that will allow the cable 6 to run though the Verlock and the nut.

In some embodiments, the eye nut is not removed and engagement elements 144 extend from the frame 1 to engage the eyebolt(s) 141.

As seen in FIG. 9, in other embodiments, the eye hook is replaced with a swiveling and/or rotatable eye nut 142 that is able to rotate away from the cable 6, such that there is an angle defined between the cable 6 and rotatable eye nut 142, when attached to the hopper via the engagement elements 144. In some embodiment, an angled eye nut 143 is employed. Wherein the angled eye nut 143 has a permanent angle as compared to the direction of the treaded hole.

The engagement elements 144 can be S-hooks, hooks, spring clips, carabineers, line, snap hooks. In some embodiments, the engagement elements is able to rotate/swivel.

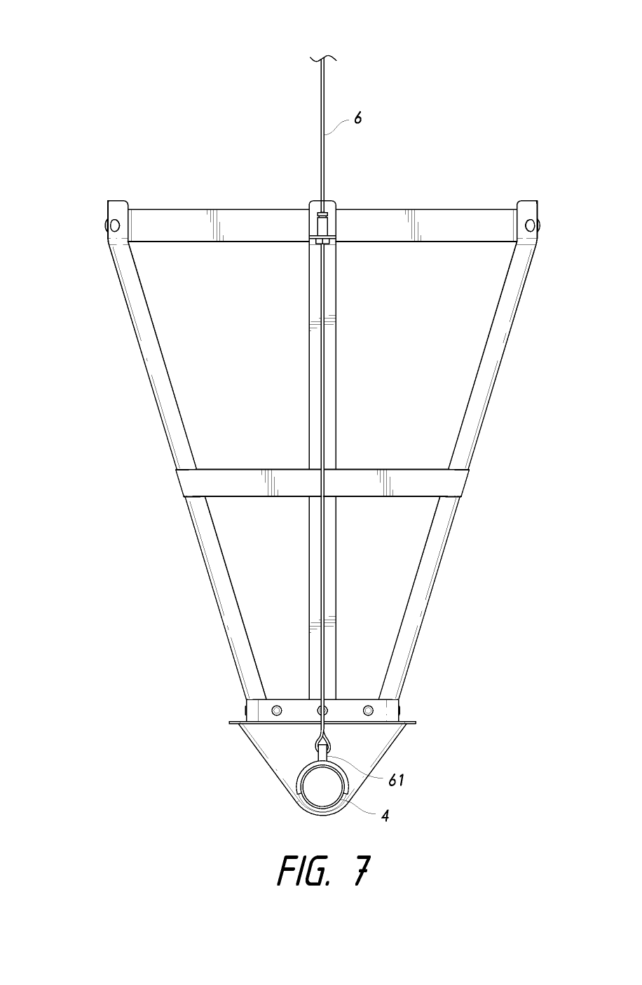

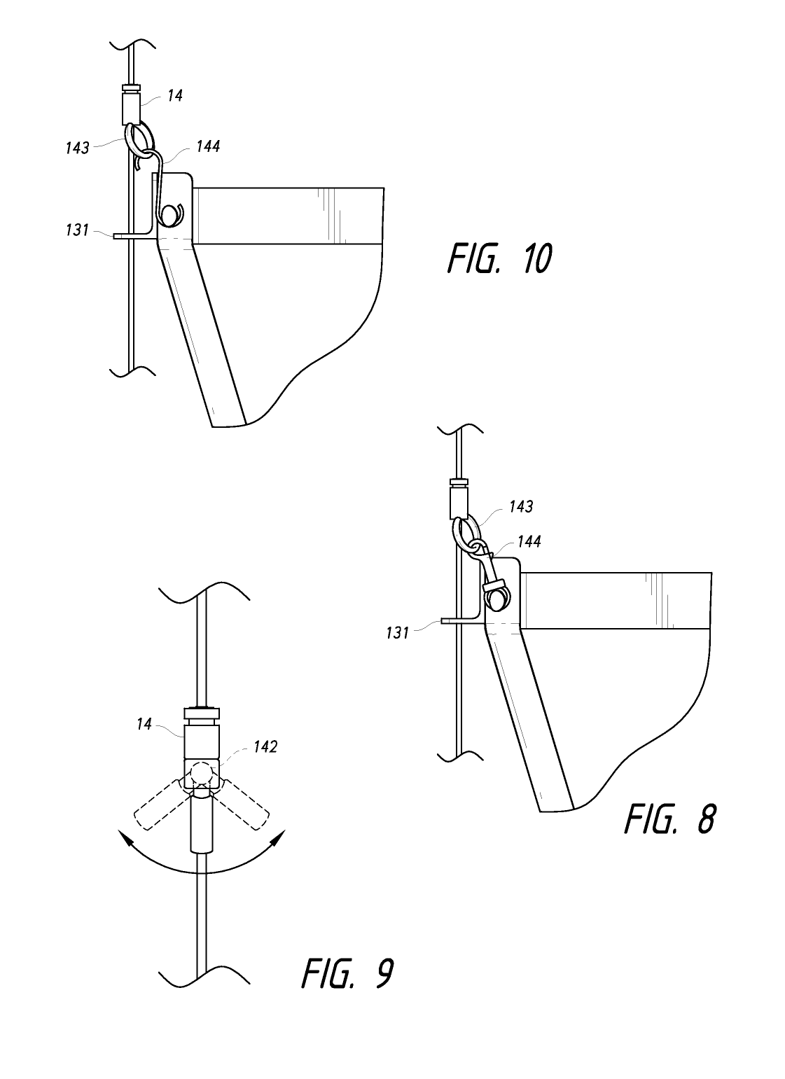

As seen in FIGS. 8 and 10, in some embodiments one or more guides 131 extend from the frame. Each guide has a hole that the cable 6 is able to run though. When the user disengages the engagement element 144 from the eye hook, the guide 131 will keep the frame 1 connected to the cable(s) 6. This will prevent the frame from sliding out of place when the hopper is put in the copplased postion, and the guide will help align the bag when placed in the extended postion and the engagement element 114 is attached to eye hook.

In some emboidments, the cable engagement member has a peremant or semi-permaninent connection to the cable 6.

When employed in a feeding system, in some embodiments, the cable 6 can be attached to the boot 4 and be in contact with the cable engagement member 14. In other embodiments, the cable 6 is attached to to the distribution conduit(s) 41. The cable 6 supports both the boot 4 and the hopper. The cable 6 is attached to a reeling mechanism that is able to lift the boot 4 and the hopper. Before lifting, a worker will release the cable engagement member 14 and collapse the hopper. Thus when the hopper and the boot 4 are reeled up, there is room for the hopper and the boot 4. Thus there is no need to remove the hopper from the system. When the system is to be deployed, the boot 4 and the hopper are lowered, and a user slides the frame 1 up the cable 6 and the hopper is able to function. This will save time and enable more people to operate the system, because the operator need not be able to lift and secure a heavy bulky hopper.

In other embodiments, the cable engagement member 14 is attached to the cable(s) 6 outside the periphery of the frame 1, and the cable engagement member 14 has an eye nut 142, 143 conttected to it. The user is able to disengage the engagement element 144 from the eye nut 142, 143, and collapse the hopper. When the user wants to place the bag 2 in the extended postion, the user will lift the frame and engage the engagement element 144 with the cable engament member 14. In some embodiments, a guide 131 is used. The guide 131 has the cable run through it so that when the bag 2 is moved from the extend to collapsed, or vice vera, the frame 1 is in proper alignment with the cable engagement member 14. This will aid in the use of the hopper. It is understood that the eye nut need not be angled. It is also understood that the eye nut may be integral with the cable engagement member 14.

The attachment 3 is used to secure the hopper to the boot 4. In one embodiment the attachment 3 comprises of fasteners that secure the bottom part of the bag 2 to the boot 4. In some embodiments, the attachment 3 will comprise a metal brace that will correspond to the desired boot 4 interface. In other embodiments, the brace comprises of plastic, wood, ceramic and/or combinations thereof. Other known attachment means can be employed to secure the hopper to the boot 4. In some embodiments, an elastic means is employed to secure the bag 2 to the boot 4.

In some embodiments, the bag 2 comprises a pouch 5. As seen in FIGS. 1, 4, and 5, the pouch 5 is able to hold a sensor 51. The sensor 51 can be a pressure sensor 51 that is able to sense the pressure from the feed residing in the bag 2. In some embodiments, the sensor 51 and the pouch 5 can have a hook and loop fastening system. The pouch 5 can have have a fastener strip that runs at least partially down the length of the pouch 5. The sensor 51 will have a corresponding fastener material located thereon. In some embodiments, a hook and loop fasterner is used. This will allow the user to easily determine the position of the sensor 51. Thus the condition in which the sensor 51 is tripped can be adjusted.

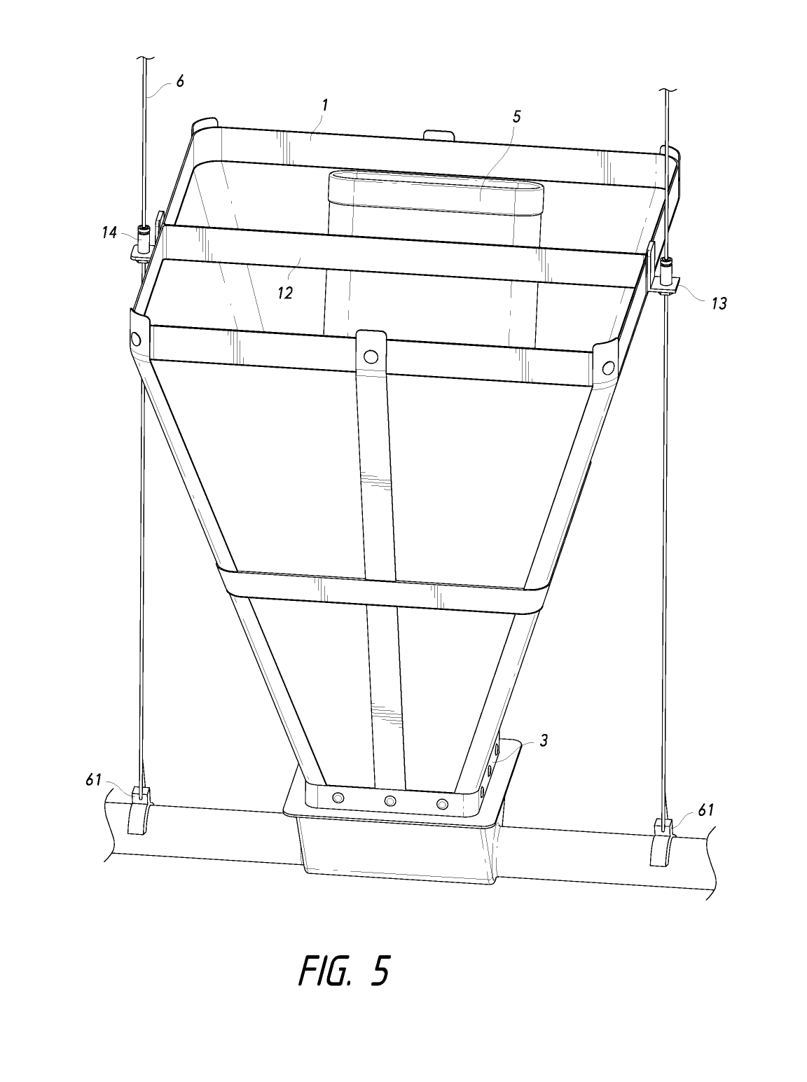

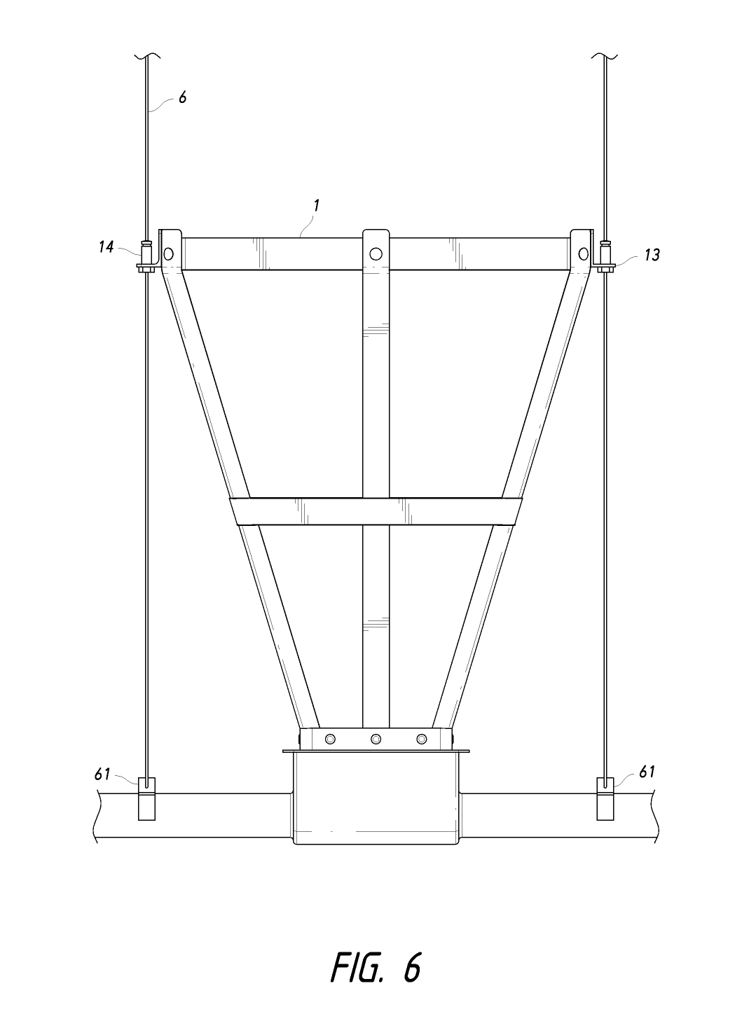

As seen in FIGS. 5-6, in some embodiments, two flanges 13 and two cable engagement members 14 are employed. The flanges extend out from the center of two sides of the exterior 11 and will align with the distribution conduits 41, when attached to the boot 4. The cables are secured to the distribution conduits 41 by bracket 61. When employed in the feeding system, two cables 6 are attached to the distribution conduits 41 on either side of the boot 4 and are connected to respective cable engagement members 14. To collapse the hopper, the cable engagement members 14 are slid down relative to the cables 6 and then secured to the cable 6. By having two engagement locations, the frame 1 is more stable. In some embodiments, a cross member 12 is not present.

It is to be understood that the above-described embodiments are intended to illustrate rather than limit the invention. Variations may be made to the embodiments without departing from the spirit of the invention as claimed. It is understood that any element of any one embodiment is considered to be disclosed to be incorporated with any other embodiment. The above-described embodiments illustrate the scope of the invention but do not restrict the scope of the invention.

1. An apparatus comprising:
a bag;
a cable comprising a linear section;
a boot;
a frame; and
a cable engagement member;
wherein the bag is connected to the frame, and the frame is connected to the cable engagement member; the bag is capable of moving between an extended position and a collapsed position; the cable is attached to the boot; the cable engagement member surrounds the cable in both the extended position, the collapsed position, and all positions therebetween; and the cable engagement member engages the linear section, and when engaged, the cable engagement member supports the frame.

2. The apparatus of claim 1, wherein the cable engagement member is a quick connect mechanism.

3. (canceled)

4. The apparatus of claim 1, further comprising a flange; wherein the flange is connected to the frame, and the cable engagement member is connected to the flange.

5. The apparatus of claim 1, further comprising a cross member and a flange; wherein the cross member is connected to the frame, and the cable engagement member is connected to the flange.

6. The apparatus of claim 5, wherein the cross member is attached to the frame at a connection point.

7. The apparatus of claim 6, wherein an angle is defined by the frame and the cross member, and the angle is in a range of about 15 degrees to 90 degrees.

8. The apparatus of claim 4, wherein the boot comprises a conduit; wherein the cable engagement member is located above and aligned with the conduit when the bag is in the extended position.

9. The apparatus of claim 1, further comprising an engagement element and an eye nut; wherein the eye nut is in contact with the cable engagement member and the engagement element is connected to the eye nut.

10. The apparatus of claim 9, wherein the eye nut is angled.

11. The apparatus of claim 5, wherein the flange is located at about a center of the cross member.

12. The apparatus of claim 1, further comprising a pouch located on an interior of the bag.

13. The apparatus of claim 12, further comprising a fastener strip located in the pouch.

14. The apparatus of claim 13, further comprising a sensor located in the pouch.

15. The apparatus of claim 4, further comprising a boot, and the boot comprises a conduit; wherein the flange and the conduit extend along the same direction when the bag is in the extended position.

16. The apparatus of claim 1, further comprising a guide and an engagement element; wherein the cable runs though the guide.

17. The apparatus of claim 16, further comprising an eye hook.

18. The apparatus of claim 1, wherein the frame has a stiffness that is greater than a stiffness of the bag.

19. An apparatus comprising
a bag;
a cable
a frame; and
a cable engagement member;
wherein the bag is connected to the frame, and the frame is connected to the cable engagement member; the bag is capable of moving between an extended position and a collapsed position; the cable is attached to an element at location below frame; and the cable engagement member is engaged with the cable in both the extended position and the collapsed position.

20. The apparatus of claim 19, wherein the cable runs through the cable engagement member, and the location is a boot.

21. An apparatus comprising
a bag;
a cable;
a frame; and
a cable engagement member;
wherein the bag is connected to the frame, and the frame is connected to the cable engagement member; the bag is capable of moving between an extended position and a collapsed position; the cable is attached to a first location, below frame, and a second location, above the cable engagement member; and the cable engagement member is engaged with the cable in both the extended position and the collapsed position.
